(19) United States
(12) Patent Application Publication
(10) Pub. No.: US 2024/0429816 A1
(43) Pub. Date: Dec. 26, 2024

(54) ACTIVE BOOTSTRAPPED-SUPPLY GENERATOR

(71) Applicant: Intel Corporation, Santa Clara, CA (US)

(72) Inventors: Nachiket Desai, Portland, OR (US); Suhwan Kim, Portland, OR (US)

(21) Appl. No.: 18/214,031

(22) Filed: Jun. 26, 2023

(51) Int. Cl. H02M 3/155; H02M 1/088

(52) U.S. Cl. CPC H02M 3/155; H02M 1/088

(57) ABSTRACT

Some embodiments include an apparatus having a first node to receive a connection from a gate of a first transistor of a voltage converter; a second node to receive a connection from a gate of a second transistor of the voltage converter; a third node to receive a connection from a node between the first and second transistors; a capacitor including a first plate coupled to the third node; a first driver including an output node coupled to the first node, a first voltage node coupled to the first plate of the capacitor, and a second voltage node coupled to a second plate of the capacitor; a second driver including an output node coupled to the second node; and a circuit including third transistors coupled in series between the second voltage node and a third voltage node.

### TECHNICAL FIELD

Embodiments described herein pertain to voltage converters. Some embodiments relate to bootstrap circuits in voltage converters.

### BACKGROUND

Voltage converters are used in many electronic devices or systems, such as computers, tablets, cellular phones, and internet of things (IoT). A voltage converter converts an input voltage (e.g., from a battery) into an internal voltage that is appropriate for use by device or system. A conventional voltage converter has transistors that can operate as switches as part of the voltage conversion. The voltage converter also has drivers to turn on or turn off the transistors. For some types of transistors, the drivers need a supply voltage that is higher than the input voltage to turn on such transistors. A bootstrapped circuit is used to generate the needed supply voltage (bootstrapped-supply voltage) for the drivers. Many bootstrapped-supply voltages are commonly generated using passive schemes with diodes. Such passive schemes can lead to inefficient operation for the voltage converter. Alternative bootstrapping schemes without diodes have been used to increase bootstrapping efficiency. However, such alternative bootstrapping schemes often use a relatively high-voltage transistor with certain transistor type (e.g., high-voltage p-type transistors) in order to pass a high voltage to the drivers. Such high-voltage transistors may be unavailable in some devices or systems depending on the types of transistors being used as switches, such as high-electron-mobility transistors (HEMTs). Further, in converters with discrete power switches, some alternative bootstrapping schemes can add a relatively higher cost associated with bootstrapping solutions.

### BRIEF DESCRIPTION OF THE DRAWINGS

FIG. 1A shows an apparatus including a voltage converter, according to some embodiments described herein.

FIG. 1B and FIG. 1C show part of the drivers of the voltage converter of FIG. 1A, according to some embodiments described herein.

FIG. 2 shows an active bootstrap switch circuit of the voltage converter of FIG. 1A, according to some embodiments described herein.

FIG. 3 shows another active bootstrap switch circuit of the voltage converter of FIG. 1A, according to some embodiments described herein.

FIG. 4 shows an apparatus in the form of a system including the voltage converter of FIG. 1A, according to some embodiments described herein.

### DETAILED DESCRIPTION

The techniques described herein involve a voltage converter and an active bootstrapping scheme without using passive devices like diodes. The described active bootstrapping scheme uses, among other circuit elements, relatively low-voltage transistors to implement an active bootstrapped-supply voltage generator. These low-voltage transistors can be formed on the same chip (e.g., same integrated circuit (IC) chip) with other low-voltage transistors (e.g., low-voltage logic devices). In an example, the transistors included in the active bootstrapped-supply voltage generator can be coupled to each other in series to form a stack of low-voltage transistors. The stack has self-referenced gate and source/drain voltages that allow the transistors to stay within safe operating regions. In another example, active bootstrapped-supply voltage generator includes a high-power n-type transistor and a charge pump to generate a boosted voltage to drive the gate of the n-type transistor.

The active bootstrapped-supply voltage generator generates the supply voltage (bootstrapped voltage) for the driver (e.g., high-side driver) of the voltage converter to allow the driver to drive (e.g., turn on) a high-side transistor (e.g., high-side switch) of the voltage converter. In an example, the high-side transistor can be a high-mobility transistor (HEMT), which can include a gallium-nitride-based (GaN-based) transistor or another kind of HEMT.

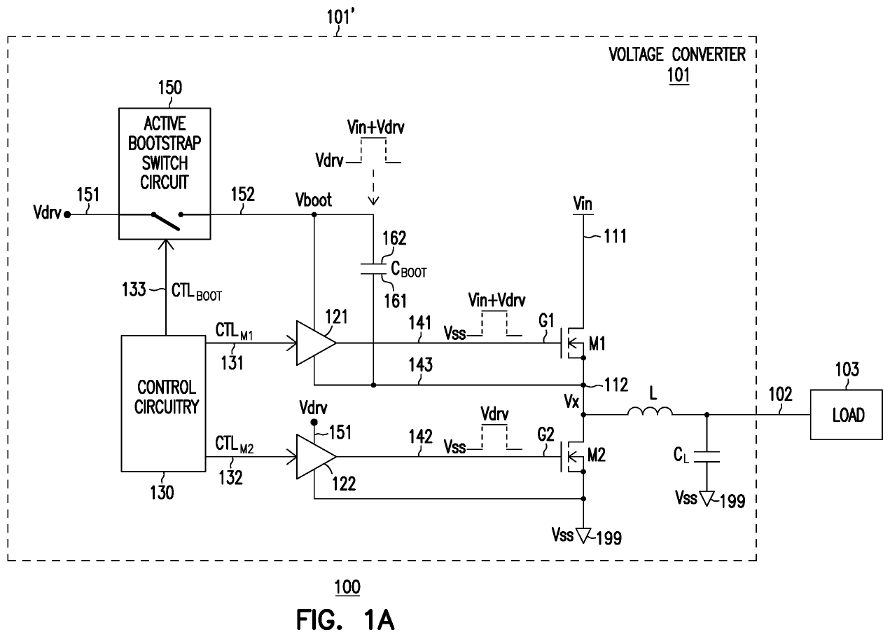

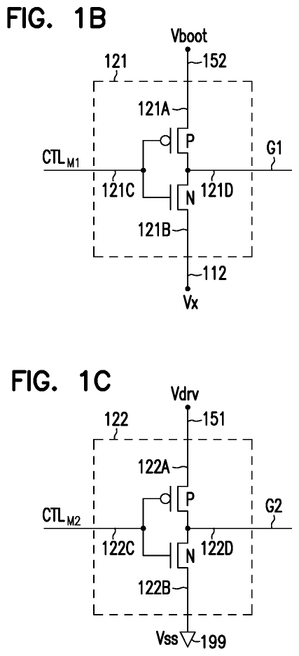

The techniques described herein allow for the use of an active bootstrap circuit in high-voltage voltage converters without using a high-voltage transistors (e.g., p-type high-power transistor) that may be unavailable or inapplicable in some high-voltage voltage converters. The described techniques also allow an active bootstrap scheme to be integrated on a low-voltage IC chip with other components of the voltage converter. This can improve efficiency and reduced cost associated with implementing an active bootstrap circuit (e.g., the described bootstrapped-supply voltage generator). These and other improvements and benefits of the described techniques are discussed in more detail below with reference to FIG. 1A through FIG. 4.

FIG. 1A shows an apparatus 100 including a voltage converter 101, according to some embodiments described herein. Apparatus 100 can include or be included in an electronic device or system, such as a computer (e.g., desktop, laptop, or notebook), a tablet, a cellular phone, a system on chip (SoC), or other electronic devices or systems. Voltage converter 101 can operate to convert a voltage (e.g., in put voltage) Vin at a node (e.g., supply node) 111 to a voltage (e.g., a switched voltage) Vx at a node 112 and provide a voltage (e.g., converted output voltage) Vout at a node 102 that is based on voltage Vx. In this description, a node can include or can be part of a conductive line. The terms “node” and “conductive line” are used interchangeably. Voltage Vin at node (or conductive line) 111 can be a supply voltage provided by a power source (e.g., a battery). The value of voltage Vout can be based on the value of voltage Vin. In an example, voltage converter 101 is part of a buck converter, such that the value of voltage Vout can be less than the value of voltage Vin. In another example, value of voltage Vout can be greater than the value of voltage Vin. Voltage Vout node 102 can be provided (e.g., as a supply voltage) to other components, such as a load 103, of apparatus 100. Examples of load 103 include a processor, such as a central processing unit (CPU) of a CPU chip or a CPU package, a graphics processing unit (GPU) of a GPU chip or a GPU package, a memory device, and other electronic components of apparatus 100.

As shown in FIG. 1A, voltage converter 101 can include (or can be included in) an integrated circuit (IC) chip (e.g., semiconductor chip) 101′. IC chip 101′ can include a semiconductor die (e.g., silicon-based die). In an example, voltage converter 101 and load 103 can be included in separate IC chips (e.g., separate IC dies). In another example, voltage converter 101 and load 103 can be included in the same IC chip (e.g., same die). In another example, voltage converter 101 and load 103, as shown in FIG. 1A, can be part of a system-on-chip (SoC).

As shown in FIG. 1A, voltage converter 101 can include transistors (e.g., switches) M1 and M2, coupled between node 111 and a node (e.g., supply node) 199 (which can be part of a supply voltage connection (e.g., ground connection) of apparatus 100). Node 199 can receive a voltage Vss (e.g., supply voltage) that can be ground potential. As shown in FIG. 1A, transistor M1 can include a gate G1, and source and drain coupled to nodes 111 and 112, respectively. Transistor M2 can include a gate G2, and source and drain coupled to nodes 112 and 199, respectively. In this description, the terms “source” and “drain” of a transistor are used interchangeably. In voltage converter 101 can include a buck converter and transistors M1 and M2 can be called high-side and low-side transistors, respectively.

In an example, at least one (one or both) of transistors M1 and M2 can include a silicon-based transistor. The silicon-based transistor can include an n-type silicon-based transistor or a p-type silicon-based transistor. An example of an n-type silicon-based transistor includes a silicon n-channel metal-oxide-semiconductor field-effect transistors (silicon n-channel MOSFET or commonly called NMOS). An example of a p-type silicon-based transistor includes a silicon p-channel metal-oxide-semiconductor field-effect transistor (silicon p-channel MOSFET or commonly called PMOS). A silicon-based transistor conducts current through a conductive channel connecting between the source and drain of the transistor in which the conductive channel can be either an n-type silicon channel (for an NMOS transistor) channel or an p-type silicon channel (for a PMOS transistor). N-type and p-type silicon-based transistors (e.g., NMOS and PMOS transistors) can be formed using complementary metal-oxide-semiconductor (CMOS) process. Thus, NMOS and PMOS transistors can be called CMOS transistors (or alternatively silicon-based CMOS transistors). In the example of FIG. 1A, each of transistors M1 and M2 can include n-type silicon channel (for a PMOS transistor).

In another example, at least one (one or both) of transistors M1 and M2 can include a non-silicon-based transistor, which can be a high-electron-mobility transistor (HEMT) that has a higher electron mobility than a silicon-based transistor. A non-silicon-based transistor (e.g., a HEMT) is a transistor that is neither silicon n-channel MOSFET nor silicon p-channel MOSFET. An example of a non-silicon-based transistor includes an n-type gallium-nitride-based (GaN-based) transistor or a p-type GaN-based transistor. In FIG. 1A, at least one of (one or both of) transistors M1 and M2 can include a GaN-based transistor (e.g., an n-type GaN-based transistor). However, transistors M1 and M2 can include other HEMTs.

A transistor normally has a voltage rating, which includes an absolute maximum drain-to-source voltage Vds (|Vds, max|) and an absolute maximum gate-to-source voltage Vgs (|Vgs, max|). The transistor can safely operate (operate without being damaged) if its Vds and Vgs do not exceed its voltage rating (e.g., do not exceed |Vds, max| and |Vds, max|). A silicon-based transistor (e.g., NMOS and PMOS in logic circuits) normally has a lower voltage rating than a non-silicon-based transistor (e.g., a HEMT, such as a GaN-based transistor).

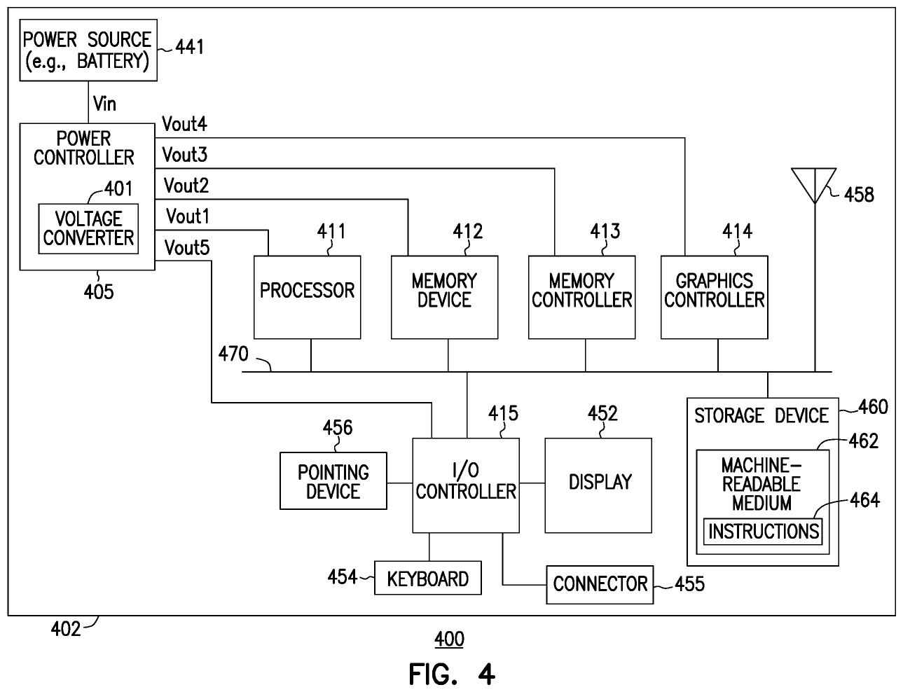

FIG. 1A shows an example where transistors M1 and M2 are included in IC chip 101′. However, transistors M1 and M2 can be excluded from (not included in) IC chip 101′. For example, transistors M1 and M2 can be outside IC chip 101′ and located on a circuit board (e.g., a printed circuit board (PCB)) where IC chip 101′ and load 103 are located. The circuit board of apparatus 100 can be similar to or the same as circuit board 402 of FIG. 4. In another example, transistors M1 and M2 can be outside IC chip 101′ and included in load 103. In another example, transistors M1 and M2 can be outside IC chip 101′ and included in another component (e.g., a semiconductor device) separated from IC chip 101′ and separated from (e.g., outside) load 103.

As shown in FIG. 1A, voltage converter 101 can include an inductor L (e.g., load inductor) coupled between nodes 112 and 102, and a capacitor CL (e.g., load capacitor) coupled between nodes 102 and 199. FIG. 1A shows an example where inductor L and capacitor CL are included in IC chip 101′. However, one or both of inductor L and capacitor CL can be excluded from (not included in) IC chip 101′. For example, one or both of inductor L and capacitor CL can be outside IC chip 101′ and located on a circuit board (e.g., a PCB). In another example, one or both of inductor L and capacitor CL can be outside IC chip 101′ and included in load 103. In another example, one or both of inductor L and capacitor CL can be outside IC chip 101′ and included in another component (e.g., a semiconductor device) separated from IC chip 101′ and separated from (e.g., outside) load 103.

As shown in FIG. 1A, voltage converter 101 can include drivers 121 and 122. Voltage converter 101 can include a node 141 formed to receive (e.g., formed to be coupled to) a connection from gate G1 of transistor M1. For example, node 141 can be coupled to gate G1 through a conductive connection. The conductive connection (e.g., electrical connection) can include metal traces, solder, or other kinds of conductive connections. Voltage converter 101 can include a node 142 formed to receive (e.g., formed to be coupled to) a connection from gate G2 of transistor M2. For example, node 142 can be coupled to gate G2 through a conductive connection. The conductive connection (e.g., electrical connection) can include metal traces, solder, or other kinds of conductive connections. Voltage converter 101 can include a node 143 formed to receive (e.g., formed to be coupled to) a connection from the node (e.g., node 112) between transistors M1 and M2.

Drivers 121 and 122 can include respective output nodes (at respective nodes 141 and 142) coupled to gates G1 and G2, respectively, of transistors M1 and M2, to drive (e.g., turn on or turn off) transistors M1 and M2, respectively. FIG. 1B and FIG. 1C show part of drivers 121 and 122, respectively.

As shown in FIG. 1B, driver 121 can include transistors P and N, which can include silicon-based transistors. For example, transistors P and N can include PMOS and NMOS, respectively, in which transistors P and N can be silicon-based CMOS transistors. Transistors P and N can have a relatively low-voltage rating. As shown in FIG. 1B, driver 121 can include nodes (e.g., supply nodes) 121A and 121B, a node (e.g., input node) 121C, and a node (e.g., output node) 121D. Node 121A can correspond to (e.g., can be) the source of transistor P. Node 121A can be coupled to a node 152 (FIG. 1) of voltage converter 101 to receive a voltage (e.g., bootstrap voltage) Vboot. Node 121B can correspond to (e.g., can be) the drain of transistor N. Node 121B can be coupled to node 112 (FIG. 1) of voltage converter 101 to receive a voltage Vdrv. Node 121C can be a common gate node of transistors P and N. Node 121C can receive a signal (e.g., input control signal) ctlm1. Node 121D can be the common drain node of transistor P and N. Node 121D can be coupled to gate G1 of transistor M1 (FIG. 1A).

As shown in FIG. 1C, driver 122 can include transistors P and N, which can include silicon-based transistors. For example, transistors P and N can include PMOS and NMOS, respectively, in which transistors P and N can be silicon-based CMOS transistors. Transistors P and N can have a relatively low-voltage rating. As shown in FIG. 1C, driver 122 can include nodes (e.g., supply nodes) 122A and 122B, a node (e.g., input node) 122C, and a node (e.g., output node) 122D. Node 122A can correspond to (e.g., can be) the source of transistor P. Node 122A can be coupled to a node 151 (FIG. 1) of voltage converter 101. Node 122B can correspond to (e.g., can be) the drain of transistor N. Node 122B can be coupled to node 199 (FIG. 1) of voltage converter 101. Node 122C can be a common gate node of transistors P and N. Node 122C can receive a signal (e.g., input control signal) ctlm2. Node 122D can be the common drain node of transistor P and N. Node 122D can be coupled to gate G2 of transistor M2 (FIG. 1A).

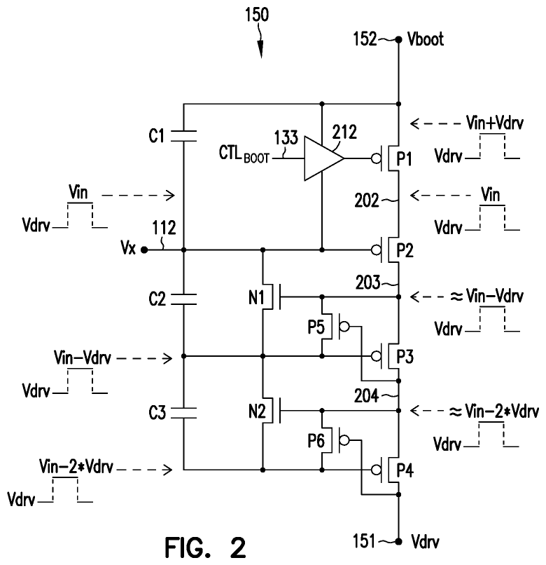

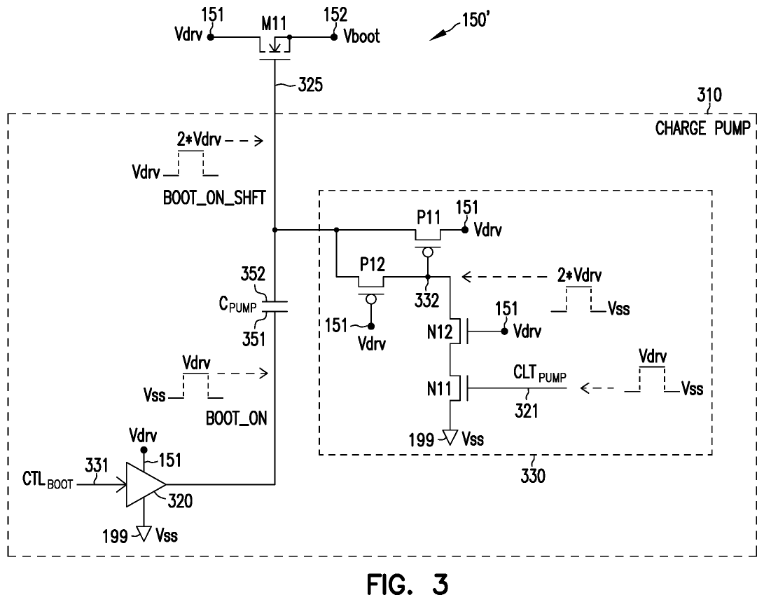

In FIG. 1A, FIG. 1B, FIG. 1C, FIG. 2, and FIG. 3, a signal symbol associated with a lower voltage (e.g., Vss) and a higher voltage (e.g., Vin) at a particular node indicates that such a particular node can have (or can be provided with) a different voltage (e.g., either a lower voltage or a higher voltage) at a different time. For example, gate G1 in FIG. 1B can be provided with (e.g., can be applied with) voltage Vss at one time and the sum of voltages Vin and Vdrv (Vin+Vdrv) at another time. Voltage Vin is greater than voltage Vdrv. The sum of voltages Vin and Vdrv is greater than voltage Vin (Vin+Vdrv>Vin). In another example, gate G2 in FIG. 1C can be provided with voltage Vss at one time and voltage Vin at another time.

As shown in FIG. 1A, voltage converter 101 can include control circuitry 130 to provide control signals CTL_{M1}, CTL_{M2}, and CTL_{BOOT}, at respective nodes 131, 132, and 133, respectively. As described below with reference to FIG. 2, circuit 150 can use signal CTL_{BOOT} to control the switching (e.g., to turn on or turn off) of transistors in circuit 150 during the operation of circuit 150.

In FIG. 1A, drivers 121 and 122 can use signals CTL_{M1} and CTL_{M2} to control (e.g., turn on or turn off) transistors M1 and M2, respectively. Control circuitry 130 can generate signals CTL_{M1} and CTL_{M2} such that transistors M1 and M2 are not currently (e.g., not simultaneously) turned on, such that when one of the transistors (e.g., transistor M1) is turned on, the other transistor (e.g., transistor M2) is turned off. For example, control circuitry 130 generates signals CTL_{M1} and CTL_{M2} such that driver 122 can turn off transistor M2 based on signal c12 and such that after transistor M2 is turned off, driver 121 can turn on transistor M1 based on signal CTL_{M1}. In the opposite, control circuitry 130 generate signals CTL_{M1} and CTL_{M2} such that driver 121 can turn off transistor M1 based on signal c12 and such that after transistor M1 is turned off, driver 122 can turn on transistor M2 based on signal CTL_{M2}.

In FIG. 1A, driver 121 can provide (e.g., apply) voltage Vss to gate G1 to turn off transistor M1 and voltage Vin+Vdrv to gate G1 to turn on transistor M1. Driver 121 can provide (e.g., apply) voltage Vss to gate G1 to turn off transistor M2 and voltage Vdrv to gate G2 to turn on transistor M2. Thus, a voltage (e.g., Vin+Vdrv) provided to (e.g., applied to) gate G1 to turn on transistor M1 is higher than a voltage (e.g., Vdrv) provided to (e.g., applied to) gate G2 to turn on transistor M2.

As shown in FIG. 1A, voltage converter 101 can include circuit (active bootstrap switch circuit) 150 coupled between node 151 and node 152. Node 151 can receive (e.g., can be provided with) voltage Vdrv. Voltage Vdrv can be either internally generated by a voltage generator (not shown) of voltage converter or externally generated by another device external to voltage converter 101. As described above, voltage Vin is greater than voltage Vdrv.

Circuit 150 is an active bootstrap switch circuit that can be (or is part of) an active bootstrapped supply generator of voltage converter 101 to generate voltage Vboot, which is the supply voltage for driver 121. Voltage Vboot is greater than voltage Vin (e.g., Vboot >Vin) to allow driver 121 to control (e.g., to drive) gate G1 of transistor M1 (FIG. 1).

Circuit 150 can operate to cause voltage Vboot at node 152 to have different values at different times. Voltage converter 101 can include a capacitor C_{BOOT} having a plate 161 coupled to node 143 (which is coupled to node 112), and a plate 162 coupled to node 152 (associated with voltage Vboot). In FIG. 1, a signal symbol associated with voltage Vdrv and voltage Vin+Vdrv (the sum of voltages Vin and Vdrv) indicates that voltage Vboot at node 152 can have a value corresponding to the value of voltage Vdrv at one time and another value corresponding to the value of voltage Vin+Vdrv at another time. Circuit 150 can include a switch operation (e.g., an active bootstrapped switch operation) that has an on state (e.g., activated state) and an off state (e.g., deactivated state). The on state can occur while transistor M1 is off (is turned off) and transistor M2 is on (is turned on). The off state can occur while transistor M1 is on (is turned on) and transistor M2 is off (is turned off).

During a time interval (e.g., while transistor M1 is off and transistor M2 is on) in the on state, circuit 150 can operate to couple node 151 to node 152 (to form a conductive path between nodes 151 and 152) and pass voltage Vdrv from node 151 to node 152. Node 112 is shorted to node 199 while transistor M1 is off and transistor M2 is on, causing the value of voltage Vx at node 112 to follow (e.g., to be equal to) the value of voltage Vss at node 199 (Vx=Vss). Plate 161 (coupled to node 112) of capacitor C_{BOOT} is charged to the value of voltage Vx at node 112 that is also the value of voltage Vss. Plate 162 (coupled to node 152) of capacitor C_{BOOT} is charged to the value of voltage Vdrv passed from node 151 to node 152. Thus, in the on state of circuit 150, voltage Vboot at node 152 has a value corresponding to (e.g., equal to) the value of voltage Vdrv (Vboot=Vdrv).

Circuit 150 can exit the on state (e.g., when transistor M2 is turned off) and enter the off state before transistor M1 is turned on. During a time interval (e.g., while transistor M2 is off and transistor M1 is on) in the off state, circuit 150 can operate to disable (break up) the conductive path between nodes 151 and 152. Transistor M1 is turned on after circuit 150 enters the off-state. Transistor M2 can be turned off before transistor M1 is turned on. Node 112 is disconnected from (not shorted to) node 199 and connected to node 111 while transistor M1 is on and transistor M2 is off. This causes the value of voltage Vx at node 112 to follow (e.g., to be equal to) the value of voltage Vin at node 111 (Vx=Vin). The value of voltage Vboot at node 152 (coupled to plate 162 of capacitor C_{BOOT}) follows the value of voltage Vx as the value of voltage Vx rises up to the value of voltage Vin with a fixed value of voltage Vdrv across capacitor C_{BOOT}. Thus, the value of voltage Vboot can increase from the value corresponding to voltage Vdrv by an amount corresponding to (e.g., equal to) the value of voltage Vin. Thus, in the off state of circuit 150, voltage Vboot at node 152 can have a value corresponding to (e.g., equal to) the sum of the values voltages Vin and Vdrv (Vboot=Vin+Vdrv).

During a time interval (e.g., while transistor M2 is off and transistor M1 is on) in the off state, voltage Vboot on node 152 can have a value higher than the voltage rating of the transistors of circuit 150. Such a value of voltage Vboot can damage transistors (described below) of circuit 150. However, as described below with reference to FIG. 2, circuit 150 can include transistors and operation to generate voltage Vboot (e.g., supply voltage of driver 121) and block a voltage equal to voltage Vin from passing from node 152 to 151 to prevent damage to the transistors of circuit 150.

FIG. 2 shows circuit 150 of FIG. 1A, including stacked transistors, according to some embodiments described herein. As shown in FIG. 2, circuit 150 can include a group (e.g., a set) of transistors (e.g., PMOS transistors) P1, P2, P3, and P4 coupled in series with each other (e.g., forming stacked transistors) between nodes 151 and 152 to form a stack of transistors P1, P2, P3, and P4. Transistors P1, P2, P3, and P4 are series-connected transistors that can be coupled in series with each other such that the source of one transistor in the group (e.g., in the stack) is coupled to the drain of another transistor in the group, as shown in FIG. 2. Circuit 150 can include transistors (e.g., PMOS transistors) P5 and P6, transistors (e.g., NMOS transistors) N1 and N2, and capacitors C1, C2, and C3. Circuit 150 can include a driver 212 to control (e.g., turn on or turn off) transistor P1 based on signal CTL_{BOOT} at node 133.

Transistors P1 through P6, N1, and N2 can include silicon-based transistors (e.g., low-voltage logic transistors) that can be formed from CMOS process. As an example, transistors P1 through P6 can include PMOS transistors (e.g., low-voltage logic PMOS transistors) and transistors N1 and N2 can include NMOS transistors (e.g., low-voltage logic NMOS transistors). Thus, transistors P1 through P6, N1, and N2 can have a relatively low-voltage rating (e.g., |Vgs, max|=Vdrv and |Vds, max|=Vdrv). As described above, transistors M1 and M2 can include either silicon-based transistors or non-silicon-based transistors (e.g., GaN-based transistor). Thus, in an example, transistors M1 and M2 can have a higher voltage rating than the voltage rating of transistors P1 through P6, N1, and N2.

In an example, transistors P1 through P6, N1, and N2 can be formed in the same process (CMOS process) as the transistors (e.g., transistors P and N in FIG. 1B and FIG. 1C) of drivers 121 and 122.

Like a signal symbol in FIG. 1A, a signal symbol associated with a lower voltage (e.g., Vdrv) and a higher voltage (e.g., Vin) in FIG. 2 indicates that a particular node can have a different voltage at a different time. In FIG. 2, the term 2*Vdrv means two times voltage Vdrv.

The stack of transistors P1, P2, and P3 has self-referenced gate and source/drain voltages (as indicated by the signal symbols) to allow transistors P1, P2, P3, and P4 to stay within safe operating regions. In the structure (e.g., the interconnections), a single signal (e.g., signal CTL_{BOOT}) can be used to bias a transistor (e.g., transistor P1). Other transistors in circuit 150 can be self-biased based on voltages at respective nodes in circuit 150, as indicated by the signal symbols in FIG. 2.

Circuit 150 can operate to concurrently turn on transistors P1, P2, P3, and P4 and concurrently turn off transistors P1, P2, P3, and P4. In circuit 150, when transistor P1 is turned on, transistors P2, P3, and P4 are also turned on. When transistor P1 is turned off, transistors P2, P3, and P4 are also turned off. Circuit 150 can operate to concurrently turn on transistors P1, P2, P3, and P4 during a time interval in the on-state of circuit 150 and concurrently turn off transistors P1, P2, P3, and P4 during a time interval in the off-state of circuit 150.

Circuit 150 may use a single control signal (e.g., only one control signal such as signal CTL_{BOOT}) to concurrently turn on or concurrently turn off transistors P1, P2, P3, and P4. As shown in FIG. 2, driver 212 can receive signal CTL_{BOOT} at its input node (not labeled). Signal CTL_{BOOT} can be activated to a signal level (e.g., voltage level) and deactivated to another signal level (e.g., another voltage level). Circuit 150 can enter the on state when signal CTL_{BOOT} is activated. Circuit 150 can exit the on state and enter the off state when signal CTL_{BOOT} is deactivated. Driver 212 can control (turn on or turn off) transistor P1 based on the signal level (e.g., voltage level) of signal CTL_{BOOT}. For example, driver 212 can turn on transistor P1 when signal CTL_{BOOT} is activated and turn off transistor P1 when signal CTL_{BOOT} is deactivated.

In the example of FIG. 2, signal CTL_{BOOT} can be level-shifted (e.g., activated or deactivated) based on the levels (e.g., logic levels) of voltages Vx and Vboot, which can be separated by voltage difference ΔV=Vdrv (e.g., Vboot−Vx=ΔV=Vdrv). Voltage Vdrv can the same as the voltage blocked by the combination of transistors P1, P2, P3, and P4. This satisfies the |Vgs, max| voltage rating of the topmost transistor (e.g., transistor P1) in the stack.

In operation, when the stack is conducting, transistor P1, P2, P3, and P4 are turned on. The values of voltages on nodes 202, 203, and 204 are the same as the value of voltage Vdrv. Transistors N1 and N2 can operate to ensure that transistors P1, P2, P3, and P4 are turned on by keeping the respective gates of transistors P1, P2, P3, and P4 at the value of voltage Vx at node 112 (shown in FIG. 1A) that is shorted to node 199 (while transistor M2 is on in the on state of circuit 150).

During a time interval in the off state of circuit 150, transistors P1, P2, P3, and P4 are turned off (e.g., not conducting). Transistors P1, P2, P3, and P4, when turned off, can block part of the total voltage (which is voltage Vin) across transistors P1, P2, P3, and P4 between nodes 151 and 152. In the off state, the value of voltage at node 202 can be set to be the value of voltage Vin by the gate (coupled to node 112) of transistor P2 that is also the value of voltage Vin (in FIG. 1, Vx=Vin when transistor M1). If the maximum |Vgs| (gate-to-source voltage) and |Vds| (drain-to-source voltage) on each of transistors P1, P2, P3, and P4 is voltage Vdrv, the selection of four transistors P1, P2, P3, and P4 in the stack between nodes 151 and 152 assumes that Vin <4*Vdrv (Vin is less than 4 times Vdrv). In FIG. 2, transistors P5 and P6 can operate to ensure that the Vgs of transistors P1, P2, P3, and P4 are zero. If Vin=4*Vdrv, the subsequent transistors in the stack all tend towards | Vgs|=0, and |Vds|=Vdrv, such that their leakage currents match. If Vin <4*Vdrv, voltages at nodes 202, 203, and 204 (e.g., intermediate drain and gate voltages) can be slightly different, but they will still be within the safe operating range of each of transistors P1, P2, P3, and P4.

FIG. 2 shows four series-connected transistors (e.g., transistors P1, P2, P3, and P4) in a stack between nodes 151 and 152 as an example. However, the number of series-connected transistors between nodes 151 and 152 can be different from four, depending on the relationship between Vin and Vdrv and the voltage rating of a single transistor of the series-connected transistors between node 151 and 152. For example, the minimum number (N) of series-connected transistors between nodes 151 and 152 can be selected based on the equation N=Vin/(Maximum Vds) across a single transistor of the series-connected transistors.

Further, due to the self-biasing nature of the series-connected transistors between nodes 151 and 152, a single control signal (e.g., like signal CTL_{BOOT}) with voltage levels between voltages Vx and Vin (which are available in voltage converter 101) can still be used to control a transistor (e.g., like transistor P1) among the transistors between nodes 151 and 152 regardless of the number of transistors between nodes 151 and 152 because other transistors (e.g., like transistors P2, P3, and P4) between nodes 151 and 152 are self-biased.

As described above with reference to FIG. 1A through FIG. 2, voltage converter 101 can have transistors of different kinds and different voltage ratings. For example, at least one of transistors M1 and M2 (e.g., transistor M1) can be a HEMT (e.g., GaN-based transistor) and other transistors (e.g., transistors P1 through P6, N1, and N2 in circuit 150) can include silicon-based transistors (e.g., NMOS and PMOS transistors). Since the transistors of circuit 150 can be low-voltage silicon-based transistors, they can be integrated on a low-voltage IC chip with other components of the voltage converter 101. This can improve efficiency and reduced cost associated with implementing an active bootstrap circuit (e.g., circuit 150).

FIG. 3 shows circuit 150′ including transistor M11 and a charge pump 310, according to some embodiments described herein. Circuit 150′ can be used as circuit 150 of FIG. 1A. Thus, circuit 150 of voltage converter 101 of FIG. 1A can include either circuit 150 of FIG. 2 or circuit 150′ of FIG. 3. Circuit 150′ can be part of a supply generator (e.g., active bootstrapped-supply generator) to generate a supply voltage (e.g., voltage Vboot at node 152) for driver 121 (FIG. 1) that is greater than voltage Vin at node 111 (e.g., Vboot >Vin) to allow driver 121 to control (e.g., to drive) gate G1 of transistor M1 (FIG. 1A).

In FIG. 3, transistor M11 can include an n-type silicon-based transistor. Alternatively, transistor M11 can include a non-silicon-based transistor. As an example, transistor M11 can include an n-type GaN transistor or other kinds of high-electron-mobility transistors (HEMTs).

As shown in FIG. 3, charge pump 310 can include a capacitor C_{PUMP} (a local capacitor in charge pump 310), a driver 320, a circuit (e.g., pump circuit) 330. Capacitor C_{PUMP} can include plates 351 and 352. Charge pump 310 can operate to raise a signal (gate control signal) BOOT_ON_SHFT at the gate (at a node 325) of transistor M11 by an amount corresponding to (e.g., equal to) the value of voltage Vin. As a result, the gate of transistor M11 at node 325 can be driven up (e.g., charged) to two times voltage Vdrv (2*Vdrv) to turn on transistor M11. This allows transistor M11 to properly pass voltage Vdrv from node 151 to node 152, so that voltage Vboot is the sum of voltages Vin and Vdrv (e.g., Vboot=Vin+Vdrv) when transistor M11 is on (is turned on).

As shown in FIG. 3, driver 320 can be coupled to nodes 151 and 199 to receive voltages Vss and Vdrv (which can be supply voltage of driver 320). Driver 320 can receive signal (e.g., control signal) CTL_{BOOT} at its input node (not labeled) that is coupled to plate 351 of capacitor C_{PUMP}. Driver 320 can generate signal BOOT_ON based on signal CTL_{BOOT}. Signal BOOT_ON can change between values corresponding to the values of voltages Vss and Vdrv. Signal CTL_{BOOT} can be generated by control circuitry 130 in FIG. 1A. In FIG. 3, signal CTL_{BOOT} can be activated to a signal level (e.g., voltage level) and deactivated to another signal level (e.g., another voltage level). Driver 320 can include silicon-based transistors (e.g., CMOS transistors) that can have a relatively low-voltage rating. In an example, driver 320 can include silicon-based transistors (e.g., like transistors P and N of driver 122 of FIG. 1C) that can operate with voltages (e.g., supply voltages) corresponding to voltages Vss and Vdrv.

As shown in FIG. 3, signal BOOT_ON_SHFT can be a level-shifted signal that can switch between different levels (e.g., voltage levels) corresponding to the values of voltages Vdrv and 2*Vdrv. Signal BOOT_ON_SHFT can be generated by DC-shifting a signal BOOT_ON. To achieve levels of Vdrv and 2*Vdrv for signal BOOT_ON_SHFT, plate 352 (at node 325) of capacitor C_{PUMP} can be charged (e.g., precharged) to voltage Vdrv during a time interval when the level of signal BOOT_ON corresponds to the value of voltage Vss (e.g., when signal CTL_{BOOT} is deactivated (not activated)). Plate 352 of capacitor C_{PUMP} can be charged to voltage 2*Vdrv during a time interval when the level of signal BOOT_ON corresponds to the value of voltage Vdrv (e.g., when signal CTL_{BOOT} is activated). Since the gate of first-time transistor M11 is coupled to node 325, the gate of transistor M11 can also be charged to voltage Vdrv (e.g., during a time interval when the level of signal BOOT_ON corresponds to the value of voltage Vss) and to voltage 2*Vdrv (e.g., during a time interval when the level of signal BOOT_ON corresponds to the value of voltage Vdrv).

Circuit 330 can include a pre-charge state to charge (e.g., precharge) node 325 to voltage Vdrv and a boot state to charge node 325 to voltage 2*Vdrv. The pre-charge state can occur when signal boot-on is at a level corresponding to the value of voltage Vss (e.g., signal CTL_{BOOT} deactivated). The boot state can occur when signal boot-on is at a level corresponding to the value of voltage Vdrv (e.g., signal CTL_{BOOT} activated).

As shown in FIG. 3, circuit 330 can include transistors (e.g., PMOS transistor) P11 and P12, and transistors (e.g., NMOS transistors) N11 and N12. Transistors P11 and P12, N11 and N12 can include silicon-based transistors (e.g., CMOS transistors) that can have a relatively low-voltage rating. For example, each of transistors P11 and P12, N11 and N12 can be a relatively low-voltage rating (e.g., |Vgs, max|=Vdrv and |Vds, max|=Vdrv).

In operation, in the precharge-state, signal CTL_{BOOT} is deactivated. Driver 320 can couple plate 351 of capacitor C_{PUMP} to node 199 (which has voltage Vss) during a time interval when signal CTL_{BOOT} is deactivated. Thus, signal boot-on can have a level corresponding to the value of voltage Vss. As shown in FIG. 3, transistors N11 and N12 can be coupled between node 199 and the gate of transistor P11. Transistor N11 can be turned on by voltage Vdrv applied at its gate (coupled to node 151). Transistor N12 can be turned on by a signal CTL_{PUMP} (e.g., generated by control circuitry 130 of FIG. 1A) that can have a level corresponding to the value of voltage Vdrv in the precharge-state. Node 332 at the gate of transistor P11 and the drain of transistor P12 is coupled to node 199 through transistors N11 and N12 when transistors N11 and N12 are turned on. Thus, in the pre-charge state, transistor P12 is turned off because its gate is connected to node 151, which has voltage Vdrv. Transistor P11 is turned on because its gate at node 332 is at voltage Vss (from node 199. The turned-on transistor P11 can couple node 325 (at plate 352 of capacitor C_{PUMP}) to node 151. Transistor P11 charges node 325 (at plate 352 of C_{PUMP}) to voltage Vdrv at node 151 (which is coupled to the drain of transistor P11).

In the pump state, signal CTL_{BOOT} is activated. Driver 320 can couple plate 351 of capacitor C_{PUMP} to node 151 (which has voltage Vdrv) during a time interval when signal CTL_{BOOT} is activated. Thus, signal boot-on can have a level corresponding to the value of voltage Vdrv. This causes node 325 to charge to voltage 2*Vdrv. In circuit 330, transistor N11 can be turned off by a signal CTL_{PUMP} that can have a level corresponding to the value of voltage Vss in the pump state. Node 332 (at the gate of transistor P11) is decoupled (disconnected) from node 199 when transistor N12 is turned off. Transistor P12 is turned on when node 325 is charged to voltage 2*Vdrv. The turned-on transistor P122 can couple node 332 to node 325 (which has a voltage 2*Vdrv). This voltage causes transistor P11 to turn off, decoupling node 325 (at plate 352 of capacitor C_{PUMP}) from node 151. In FIG. 3, transistors N11 and N12 are included in charge pump 310 to block a total voltage equal to 2*Vdrv from node 325 when transistor P12 is on (is turned on) in the boot mode.

Circuit 150′ allows voltage converter 101 to have similar improvements and benefits like circuit 150 of FIG. 2. For example, since transistors N11, N12, P11, and P12 can be low-voltage silicon-based transistors, they can be integrated on a low-voltage IC chip with other components of the voltage converter 101. This can improve efficiency and reduced cost associated with implementing an active bootstrap circuit (e.g., circuit 150′).

FIG. 4 shows an apparatus in the form of a system (e.g., electronic system) 400, according to some embodiments described herein. System 400 can be viewed as a machine. System (e.g., machine) 400 can include or be included in a computer, a cellular phone, or other electronic systems. As shown in FIG. 4, system 400 can include components (e.g., devices) located on a circuit board (e.g., a PCB) 402. As shown in FIG. 4, system 400 can include a power controller 405, a processor (e.g., hardware processor) 411, a memory device 412, a memory controller 413, a graphics controller 414, an input and output (I/O) controller 415, a display 452, a keyboard 454, a pointing device 456, at least one antenna 458, a storage device 460, and a bus 470. Bus 470 can include conductive lines (e.g., metal-based traces on a circuit board 402 where the components of system 400 are located).

System 400 may be configured to perform one or more of the methods and/or operations described herein. At least one of the components of system 400 (e.g., at least one of power controller 405, processor 411, memory device 412, memory controller 413, graphics controller 414, and I/O controller 415) can include at least one of voltage converter 101 and load 103 of FIG. 1.

In FIG. 4, processor 411 can include a general-purpose processor or an application-specific integrated circuit (ASIC). Processor 411 can include a CPU and processing circuitry. Graphics controller 414 can include a GPU and processing circuitry. Memory device 412 can include a dynamic random-access memory (DRAM) device, a static random-access memory (SRAM) device, a flash memory device, phase change memory, or a combination of these memory devices, or other types of memory. FIG. 4 shows an example where memory device 412 is a stand-alone memory device separated from processor 411. In an alternative arrangement, memory device 412 and processor 411 can be located on the same IC chip (e.g., same ID die). In such an alternative arrangement, memory device 412 is an embedded memory in processor 411, such as embedded DRAM (eDRAM), embedded SRAM (eSRAM), embedded flash memory, or another type of embedded memory.

Storage device 460 can include drive unit (e.g., hard disk drive (HHD), solid-state drive (SSD), or another mass storage device). Storage device 460 can include a machine-readable medium 462 and processing circuitry. Machine-readable medium 462 can store one or more sets of data structures or instructions 464 (e.g., software) embodying or used by any one or more of the techniques or functions described herein. Instructions 464 may also reside, completely or at least partially, within power controller 405, processor 411, memory device 412, memory controller 413, graphics controller 414 during execution thereof by system (e.g., machine) 400.

In an example, one of (or any combination of) power controller 405, processor 411, memory device 412, memory controller 413, graphics controller 414, and storage device 460 may constitute machine-readable media. Non-limiting machine-readable medium examples may include solid-state memories and optical and magnetic media. Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

FIG. 4 shows machine-readable medium 462 as a single medium as an example. However, the term “machine-readable medium” may include a single medium or multiple media (e.g., a centralized or distributed database, and/or associated caches and servers) configured to store instructions 464. Further, the term “machine-readable medium” may include any medium that is capable of storing, encoding, or carrying instructions for execution by system 400 and that causes system 400 to perform any one or more of the techniques of the present disclosure, or that is capable of storing, encoding or carrying data structures used by or associated with such instructions. In some examples, machine-readable media may include non-transitory machine-readable media. In some examples, machine-readable media may include machine-readable media that is not a transitory propagating signal.

Display 452 can include a liquid crystal display (LCD), a touchscreen (e.g., capacitive or resistive touchscreen), or another type of display. Pointing device 456 can include a mouse, a stylus, or another type of pointing device. In some structures, system 400 does not have to include a display. Thus, in such structures, display 4522 can be omitted from system 400.

Antenna 458 can include one or more directional or omnidirectional antennas, including, for example, dipole antennas, monopole antennas, patch antennas, loop antennas, microstrip antennas, or other types of antennas suitable for transmission of radio frequency (RF) signals. In some structures, system 400 does not have to include an antenna. Thus, in such structures, antenna 458 can be omitted from system 400.

I/O controller 415 can include a communication module for wired or wireless communication (e.g., communication through one or more antennas 458). Such wireless communication may include communication in accordance with WiFi communication technique, Long Term Evolution Advanced (LTE-A) communication technique, or other communication techniques.

I/O controller 415 can also include a module to allow system 400 to communicate with other devices or systems in accordance with to one or more of the following standards or specifications (e.g., I/O standards or specifications), including Universal Serial Bus (USB), DisplayPort (DP), High-Definition Multimedia Interface (HDMI), Thunderbolt, Peripheral Component Interconnect Express (PCIe), Ethernet, and other specifications.

Connector 455 can include terminals (e.g., pins) to allow system 400 to be coupled to an external device (or system). This may allow system 400 to communicate (e.g., exchange information) with such a device (or system) through connector 455. Connector 455 and at least a portion of bus 470 can include conductive lines that conform with at least one of USB, DP, HDMI, Thunderbolt, PCIe, Ethernet, and other specifications.

Power controller 405 can be configured to receive power (e.g., supply voltage) from a power source 441 that can provide a voltage Vin, which can correspond to voltage Vin described above with reference to FIG. 1A through FIG. 3. Power controller 405 can provide voltages Vout₁, Vout₂, Vout₃, Vout₄, and Vout₅ based on voltage Vin. Each of voltages Vout₁, Vout₂, Vout₃, Vout₄, and Vout₅ can correspond to voltage Vout described about with reference to FIG. 1A through FIG. 3. Voltages Vout₁, Vout₂, Vout₃, Vout₄, and Vout₅ can be provided to processor 411, memory device 412, memory controller 413, graphics controller 414, and I/O controller 415, respectively.

Power controller 405 can include at least one voltage converter 401 that can be part of voltage conversion operations of power controller 405 to provide voltages Vout₁, Vout₂, Vout₃, Vout₄, and Vout₅ in ways similar to, or the same as, providing of voltage Vout by voltage converter 101 described above with reference to FIG. 1A or FIG. 3.

FIG. 4 shows the components of system 400 arranged separately from each other as an example. For example, each of power controller 405, processor 411, memory device 412, memory controller 413, graphics controller 414, and I/O controller 415 can be located on a separate IC chip (e.g., separate die). In some arrangements, two or more components (e.g., power controller 405, processor 411, memory device 412, graphics controller 414, and I/O controller 415) of system 400 can be located on the same chip (e.g., same die), forming a system-on-chip.

The illustrations of the apparatuses (e.g., voltage converter 101 and system 400) and methods (e.g., method of operating voltage converter 101 and system 400) described above are intended to provide a general understanding of the structure of different embodiments and are not intended to provide a complete description of all the elements and features of an apparatus that might make use of the structures described herein. An apparatus herein refers to, for example, either a device (e.g., voltage converter 101) or a system (e.g., system 400 that can include voltage converter 101, load 103, or both).

Any of the components described above with reference to FIG. 1A through FIG. 4 can be implemented in a number of ways, including simulation via software. Thus, apparatuses (e.g., voltage converter 101 or part of voltage converter 101) may all be characterized as “modules” (or “module”) herein. Such modules may include hardware circuitry, single- and/or multi-processor circuits, memory circuits, software program modules and objects and/or firmware, and combinations thereof, as desired and/or as appropriate for particular implementations of various embodiments. For example, such modules may be included in a system operation simulation package, such as a software electrical signal simulation package, a power usage and ranges simulation package, a capacitance-inductance simulation package, a power/heat dissipation simulation package, a signal transmission-reception simulation package, and/or a combination of software and hardware used to operate or simulate the operation of various potential embodiments.

The apparatuses and methods described above can include or be included in high-speed computers, communication and signal processing circuitry, single- or multi-processor modules, single or multiple embedded processors, multicore processors, message information switches, and application-specific modules including multilayer, multichip modules. Such apparatuses may further be included as subcomponents within a variety of other apparatuses (e.g., electronic systems), such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others.

In the detailed description and the claims, the terms “first,” “second,” and “third,” etc. are used merely as labels, and are not intended to impose numerical requirements on their objects.

In the detailed description and the claims, the term “adjacent” generally refers to a position of a thing being next to (e.g., either immediately next to or close to with one or more things between them) or adjoining another thing (e.g., abutting it or contacting it (e.g., directly coupled to) it).

In the detailed description and the claims, a list of items joined by the term “at least one of” can mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A can include a single element or multiple elements. Item B can include a single element or multiple elements. Item C can include a single element or multiple elements.

In the detailed description and the claims, a list of items joined by the term “one of” can mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A can include a single element or multiple elements. Item B can include a single element or multiple elements. Item C can include a single element or multiple elements.

Example 1 includes subject matter (such as a device, an electronic apparatus (e.g., circuit, electronic system, or both), or a machine) comprising: an electronic apparatus comprising a first node to receive a connection from a gate of a first transistor of a voltage converter, a second node to receive a connection from a gate of a second transistor of the voltage converter, a third node coupled to a node between the first and second transistors, a capacitor including a first plate coupled to the third node, a first driver including an output node coupled to the first node, a first voltage node coupled to the first plate of the capacitor, and a second voltage node coupled to a second plate of the capacitor, a second driver including an output node coupled to the second node, and a circuit including third transistors coupled in series between the second voltage node and a third voltage node.

In Example 2, the subject matter of Example 1 includes subject matter wherein the third transistors have a same transistor type.

In Example 3, the subject matter of any of Examples 1-2 includes subject matter wherein at least one of the first and second transistors is a non-silicon-based transistor.

In Example 4, the subject matter of any of Examples 1-3 includes subject matter wherein at least one of the first and second transistors is a Gallium-nitride-based (GaN-based) transistor.

In Example 5, the subject matter of any of Examples 1-4 includes, a first additional transistor coupled between gates of two respective transistors of the third transistors, and a second additional transistor including a source coupled to a gate of the first additional transistor and to a drain of a first transistor in the two respective transistors, and a drain coupled to a gate of a second transistor in the two respective transistors.

In Example 6, the subject matter of Example 5 includes, an additional capacitor coupled between the gates of the two respective transistors.

In Example 7, the subject matter of any of Examples 1-6 includes subject matter wherein the circuit is a part of a bootstrapped-supply generator to cause a voltage at the first voltage node to be greater than a voltage at the first node.

In Example 8, the subject matter of any of Example 1-7 includes subject matter wherein the first and second drivers, the capacitor, and the circuit are included in an integrated circuit (IC) chip, and the first and second transistors are outside the IC chip.

In Example 9, the subject matter of any of Examples 1-7 includes subject matter wherein the first and second drivers, the capacitor, and the circuit are included in an integrated circuit (IC) chip, and the first and second transistors are included in the IC chip.

In Example 10, the subject matter of any of Examples 1-9 includes subject matter wherein the first transistor has a higher voltage rating than each of the third transistors.

In Example 11, the subject matter of any of Examples 1-10 includes subject matter wherein the first transistor is a high-side transistor of a voltage converter, the second transistor is a low-side transistor of the voltage converter.

In Example 12, the subject matter of any of Examples 1-11 includes subject matter wherein the first transistor is coupled between an input node of the voltage converter and an output node of the converter, and the first transistor is a high-side transistor of a voltage converter, and a total number of the third transistors is based on a relationship between an input voltage at the input node and a voltage-rating of one transistor of the third transistors.

In Example 13, the subject matter of any of Examples 1-9 includes subject matter wherein the first and second transistors are n-type transistors.

In Example 14, the subject matter of any of Examples 1-9 includes subject matter wherein the third transistors have a same p-type transistor.

In Example 15, the subject matter of any of Examples 1-9 includes, a driver including an output node coupled to a gate of one of the third transistors, the driver including a first node coupled to the first voltage node of the first driver, and a second node coupled to the third node between the first and second transistors.

In Example 16, the subject matter of any of Example 1-15 includes, a processor, and a power controller coupled to the processor, wherein the power controller includes the first and second drivers, the capacitor, and the circuit.

Example 17 includes subject matter (such as a device, an electronic apparatus (e.g., circuit, electronic system, or both), or a machine) comprising: a first node to receive a connection from a gate of a first transistor of a voltage converter, a second node to receive a connection from a gate of a second transistor of the voltage converter, a third node to receive a connection from a node between the first and second transistors, a capacitor including a first plate coupled to the third node, a first driver including an output node coupled to the first node, a first voltage node coupled to the first plate of the capacitor, and a second voltage node coupled to a second plate of the capacitor, a second driver including an output node coupled to the second node, an n-type transistor coupled between the second voltage node and a third voltage node, and a charge pump coupled to a gate of the n-type transistor.

In Example 18, the subject matter of Example 16 includes subject matter wherein the charge pump is a part of a bootstrapped-supply generator to cause a voltage at the first voltage node to be greater than a voltage at the first node.

In Example 19, the subject matter of any of Examples 17-18 includes subject matter wherein the first transistor is a high-side transistor of a voltage converter, the second transistor is a low-side transistor of the voltage converter.

In Example 20, the subject matter of any of Examples 16-18 includes subject matter wherein the charge pump includes an additional capacitor including a first plate coupled to the gate of the n-type transistor, a driver including an output node coupled a second plate of the capacitor, and a circuit including a third transistor coupled between the first plate of the additional capacitor and the third voltage node.

In Example 21, the subject matter of Example 20 includes subject matter wherein the circuit includes a fourth transistor coupled between the first plate of the additional capacitor and a gate of the third transistor, and transistors coupled in series between the gate of the third transistor and a supply node.

In Example 22, the subject matter of Example 20 includes subject matter wherein the third and fourth transistors have a first transistor type, and the transistors coupled in series between the gate of the third transistor and the supply node have a second transistor type.

In Example 23, the subject matter of any of Examples 17-22 includes subject matter wherein the n-type transistor has a higher voltage rating than the third transistor.

In Example 24, the subject matter of any of Examples 20-23 includes subject matter wherein the driver includes a first node coupled to an output node coupled to a gate of one of the transistors, the driver including a first supply node coupled to the third node, and a second supply node coupled to a supply node of the voltage converter.

In Example 25, the subject matter of any of Examples 20-24 includes subject matter wherein the first and second transistors are n-type transistors.

In Example 26, the subject matter of any claims 20-24 includes subject matter wherein at least one of the first and second transistors is a Gallium nitride-based (GaN-based) transistor.

In Example 27, the subject matter of any of Examples 17-26 includes, a connector and an integrated circuit (IC) chip coupled to the connector, the IC chip including a voltage converter, the voltage converter including the capacitor, the first driver, the second driver, the n-type transistor, and the charge pump, wherein the connector conforms with at least one of Universal Serial Bus (USB), High-Definition Multimedia Interface (HDMI), Thunderbolt, Peripheral Component Interconnect Express (PCIe), and Ethernet specifications.

Example 28 includes subject matter (such as a method of operating a device, an electronic apparatus (e.g., circuit, electronic system, or both), or a machine, and/or a method of forming a device, an electronic apparatus, or a machine) comprising: charging, during a first time interval, a capacitor to a first voltage, the capacitor being coupled to a supply node of a driver, the driver including an output node coupled to a high-side transistor of a voltage converter, charging, during a second time interval, the capacitor to a second voltage greater than the first voltage, turning off series-connected transistors during the first time interval, the series-connected transistors being coupled between the supply node of the driver and a voltage node, and turning on the series-connected transistors during the second time interval includes subject matter wherein the second voltage is based on the first voltage and a voltage at the voltage node during the second time interval.

In Example 29, the subject matter of Example 28 includes subject matter wherein turning on the series-connected transistors includes using only one control signal to turn on the series-connected transistors.

In Example 30, the subject matter of any of Examples 28-29 includes, turning off the series-connected transistors includes subject matter wherein turning off the series-connected transistors includes using only one control signal to turn off the series-connected transistors.

In Example 31, the subject matter of any of Examples 28-30 includes, turning on a low-side transistor of the voltage converter during the first time interval, turning off the low-side transistor during the second time interval, turning off the high-side transistor during the first time interval, and turning on the high-side transistor during the second time interval.

Example 32 includes subject matter (such as a method of operating a device, an electronic apparatus (e.g., circuit, electronic system, or both), or a machine, and/or a method of forming a device, an electronic apparatus, or a machine) comprising: charging, during a first time interval, a gate of a transistor to a first voltage, the transistor being coupled between a first voltage node and a first supply node of a driver, the driver including an output node coupled to a high-side transistor of a voltage converter, charging, during a second time interval, the gate of the transistor to a second voltage greater than the first voltage, and wherein charging the gate of the transistor during the first time interval and the second time interval includes coupling a first plate of a capacitor to a second supply node during the first time interval, coupling a second plate of the capacitor to the first voltage node during the first time interval includes subject matter wherein the second plate of the capacitor is coupled to the gate of the transistor, coupling the first plate of a capacitor to a second voltage node during the second time interval, and decoupling the second plate of the capacitor from the first voltage node during the second time interval.

In Example 33, the subject matter of Examples 32 includes subject matter wherein the transistor coupled between the first voltage node and the supply node of the driver is an n-type transistor.

In Example 34, the subject matter of Example 33 includes subject matter wherein coupling a second plate of the capacitor to the first voltage node during the first time interval includes turning on transistors coupled between a gate of a first additional transistor and the second supply node includes subject matter wherein the first additional transistor is coupled between the second plate of the capacitor and the first voltage node.

In Example 35, the subject matter of Example 34 includes subject matter wherein decoupling the second plate of the capacitor from the first voltage node during the second time includes turning off the transistors coupled between the gate of the first additional transistor and the second supply node, and turning on a second additional transistor coupled between the second plate of the capacitor and the gate of the first additional transistor.

Example 36 is an apparatus comprising means to implement any of Examples 1-35.

Example 37 is a system to implement any of Examples 1-35.

Example 38 is a method to implement any of Examples 1-35.

The subject matter of Examples 1-36 may be combined in any combination.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a first node to receive a connection from a gate of a first transistor of a voltage converter;
a second node to receive a connection from a gate of a second transistor of the voltage converter;
a third node to receive a connection from a node between the first and second transistors;
a capacitor including a first plate coupled to the third node;
a first driver including an output node coupled to the first node, a first voltage node coupled to the first plate of the capacitor, and a second voltage node coupled to a second plate of the capacitor;
a second driver including an output node coupled to the second node; and
a circuit including third transistors coupled in series between the second voltage node and a third voltage node.

2. The apparatus of claim 1, wherein the third transistors have a same transistor type.

3. The apparatus of claim 1, wherein at least one of the first and second transistors is a non-silicon-based transistor.

4. The apparatus of claim 1, wherein at least one of the first and second transistors is a Gallium-nitride-based (GaN-based) transistor.

5. The apparatus of claim 1, further comprising:
a first additional transistor coupled between gates of two respective transistors of the third transistors; and
a second additional transistor including a source coupled to a gate of the first additional transistor and to a drain of a first transistor in the two respective transistors, and a drain coupled to a gate of a second transistor in the two respective transistors.

6. The apparatus of claim 5, further comprising an additional capacitor coupled between the gates of the two respective transistors.

7. The apparatus of claim 1, wherein the circuit is a part of a bootstrapped-supply generator to cause a voltage at the first voltage node to be greater than a voltage at the first node.

8. The apparatus of claim 1, wherein the first and second drivers, the capacitor, and the circuit are included in an integrated circuit (IC) chip, and the first and second transistors are outside the IC chip.

9. The apparatus of claim 1, further comprising:
a processor; and
a power controller coupled to the processor, wherein the power controller includes the first and second drivers, the capacitor, and the circuit.

10. An apparatus comprising:
a first node to receive a connection from a gate of a first transistor of a voltage converter;
a second node to receive a connection from a gate of a second transistor of the voltage converter;
a third node to receive a connection from a node between the first and second transistors;
a capacitor including a first plate coupled to the third node;
a first driver including an output node coupled to the first node, a first voltage node coupled to the first plate of the capacitor, and a second voltage node coupled to a second plate of the capacitor;
a second driver including an output node coupled to the second node;
an n-type transistor coupled between the second voltage node and a third voltage node; and
a charge pump coupled to a gate of the n-type transistor.

11. The apparatus of claim 10, wherein the charge pump is a part of a bootstrapped-supply generator to cause a voltage at the first voltage node to be greater than a voltage at the first node.

12. The apparatus of claim 10, wherein the first transistor is a high-side transistor of a voltage converter, the second transistor is a low-side transistor of the voltage converter.

13. The apparatus of claim 10, wherein the charge pump includes:
an additional capacitor including a first plate coupled to the gate of the n-type transistor;
a driver including an output node coupled a second plate of the capacitor; and
a circuit including a third transistor coupled between the first plate of the additional capacitor and the third voltage node.

14. The apparatus of claim 13, wherein the circuit includes:
a fourth transistor coupled between the first plate of the additional capacitor and a gate of the third transistor; and
transistors coupled in series between the gate of the third transistor and a supply node.

15. The apparatus of claim 13, wherein the n-type transistor has a higher voltage rating than the third transistor.

16. The apparatus of claim 10, further comprising a connector and an integrated circuit (IC) chip coupled to the connector, the IC chip including a voltage converter, the voltage converter including the capacitor, the first driver, the second driver, the n-type transistor, and the charge pump, wherein the connector conforms with at least one of Universal Serial Bus (USB), High-Definition Multimedia Interface (HDMI), Thunderbolt, Peripheral Component Interconnect Express (PCIe), and Ethernet specifications.

17. A method comprising:
charging, during a first time interval, a capacitor to a first voltage, the capacitor being coupled to a supply node of a driver, the driver including an output node coupled to a high-side transistor of a voltage converter;
charging, during a second time interval, the capacitor to a second voltage greater than the first voltage;
turning off series-connected transistors during the first time interval, the series-connected transistors being coupled between the supply node of the driver and a voltage node; and
turning on the series-connected transistors during the second time interval, wherein the second voltage is based on the first voltage and a voltage at the voltage node during the second time interval.

18. The method of claim 17, wherein turning on the series-connected transistors includes using one control signal to turn on the series-connected transistors.

19. The method of claim 17, further comprising:
turning off the series-connected transistors, wherein turning off the series-connected transistors includes using one control signal to turn off the series-connected transistors.

20. The method of claim 17, further comprising:
turning on a low-side transistor of the voltage converter during the first time interval;
turning off the low-side transistor during the second time interval;
turning off the high-side transistor during the first time interval; and
turning on the high-side transistor during the second time interval.
